(19) United States
(12) Patent Application Publication
(10) Pub. No.: US 2011/0128136 A1
(43) Pub. Date: Jun. 2, 2011

(54) ON-VEHICLE DEVICE AND RECOGNITION SUPPORT SYSTEM

(75) Inventors: Tetsuhiro KATOH, Kobe-shi (JP); Satoshi HARUMOTO, Kobe-shi (JP); Kimitaka MURASHITA, Kobe-shi (JP); Takechika KIRIYA, Kobe-shi (JP)

(73) Assignee: FUJITSU TEN LIMITED, Kobe-shi (JP)

(21) Appl. No.: 12/942,371

(22) Filed: Nov. 9, 2010

(30) Foreign Application Priority Data
Nov. 30, 2009 (JP) 2009-272860

(51) Int. Cl. B60Q 1/00

(52) U.S. Cl. 340/435

(57) ABSTRACT

There is provided an on-vehicle device including an image acquisition unit, a moving-object detector, a display unit, a switching unit, and a switching instruction unit. The image acquisition unit acquires an image obtained by imaging a peripheral image around a vehicle. The moving-object detector, when the vehicle approaches an intersection, detects whether there is a moving object approaching the vehicle as an own vehicle from a left or a right direction of the intersection based on the peripheral image. The switching unit switches between images in a plurality of systems input to a display unit. The switching instruction unit instructs to switch to the peripheral image when the moving object is detected.

### CROSS-REFERENCE TO RELATED APPLICATION

This application is based upon and claims the benefit of priority of the prior Japanese Patent Application No. 2009-272860, filed on Nov. 30, 2009, the entire contents of which are incorporated herein by reference.

### BACKGROUND OF THE INVENTION

1. Field of the Invention

The present invention relates to an on-vehicle device mounted on a vehicle and a recognition support system including the on-vehicle device.

2. Description of the Related Art

Conventionally, there is known an on-vehicle device provided with a blind corner monitor (hereinafter described as “BCM”) for displaying an image obtained by imaging a side ahead of a vehicle or a rearward thereof, by a camera, which is a blind corner for a driver.

For example, Japanese Patent Application Laid-open No. 2009-67292 discloses an on-vehicle device that switches, when it is detected that an own vehicle is about to enter an intersection based on position information of the own vehicle and road information, from a screen displayed on a display unit or from a map as a navigation function (hereinafter described as a “navigation screen”) to a camera image, and displays the camera image. This allows a driver to visually recognize an area becoming a blind corner for him or her through the camera image.

There is also known an on-vehicle device that switches, if a running speed of an own vehicle becomes low, for example, if it becomes 10 kilometers per hour or less, from a navigation screen to a camera image of a side ahead of the vehicle imaged by a camera mounted on the own vehicle, and displays the camera image.

However, in the on-vehicle devices described above, when the own vehicle approaches the intersection or if the running speed of the own vehicle becomes low, the switching to the camera image is always performed. Therefore, there is a problem that the switching to the camera image is performed even if there is no vehicle approaching the own vehicle.

Besides, in the on-vehicle devices described above, because the switching to the camera image is performed frequently (each time the own vehicle approaches an intersection), this switching may annoy particularly the driver who wants to keep on checking the navigation screen.

Moreover, if the switching to the camera image is frequently performed, then this causes the driver to become less conscious of caution against an approaching vehicle, and thus, there is also a problem that even if the camera image is displayed, the driver neglects checking of the camera image.

Thus, it remains a big challenge how to achieve an on-vehicle device and a recognition support system capable of allowing a driver to reliably recognize the presence of a moving object approaching an own vehicle from a blind corner for the driver while causing the driver to maintain a sense of caution against a dangerous object.

### SUMMARY OF THE INVENTION

It is an object of the present invention to at least partially solve the problems in the conventional technology.

An on-vehicle device according to one aspect of the present invention is mounted on a vehicle and includes an image acquisition unit that acquires an image obtained by imaging a peripheral image around the vehicle, a moving-object detector that detects whether there is a moving object approaching the vehicle as an own vehicle from the peripheral image based on own-vehicle information indicating running conditions of the own vehicle, a switching unit that switches between images in a plurality of systems input to a display unit, and a switching instruction unit that instructs the switching unit to switch to the peripheral image when the moving object is detected by the moving-object detector.

A recognition support system according to another aspect of the present invention includes an on-vehicle device mounted on a vehicle and a ground server device that performs wireless communication with the on-vehicle device. The ground server device includes a transmission unit that transmits peripheral information around the vehicle to the vehicle. The on-vehicle device includes a reception unit that receives the peripheral information from the ground server device, an image acquisition unit that acquires an image obtained by imaging a peripheral image around the vehicle, a moving-object detector that detects whether there is a moving object approaching the vehicle as an own vehicle from the peripheral image based on the peripheral information received by the reception unit and own-vehicle information indicating running conditions of the own vehicle, a switching unit that switches between images in a plurality of systems input to a display unit, and a switching instruction unit that instructs the switching unit to switch to the peripheral image when the moving object is detected by the moving-object detector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A, 1B-1 to 1B-3, 1C-1, and 1C-2 are diagrams illustrating an overview of an on-vehicle device and a recognition support system according to the present invention;

FIG. 2 is a block diagram of a configuration of the on-vehicle device according to an embodiment of the present invention;

FIGS. 3A to 3C are diagrams illustrating examples of a mounting pattern of a camera;

FIGS. 4A and 4B are diagrams for explaining a moving-object detection process;

FIGS. 5A to 5C are diagrams for explaining risk information;

FIG. 6 is a flowchart representing an overview of a procedure for a recognition support process executed by the on-vehicle device;

FIG. 7 is a block diagram of a configuration of a recognition support system according to a modification;

FIG. 8 is a diagram for explaining one example of a method of varying threshold values; and

FIG. 9 is a flowchart representing a modification of a procedure for a recognition support process executed by the on-vehicle device.

### DETAILED DESCRIPTION OF THE PREFERRED EMBODIMENTS

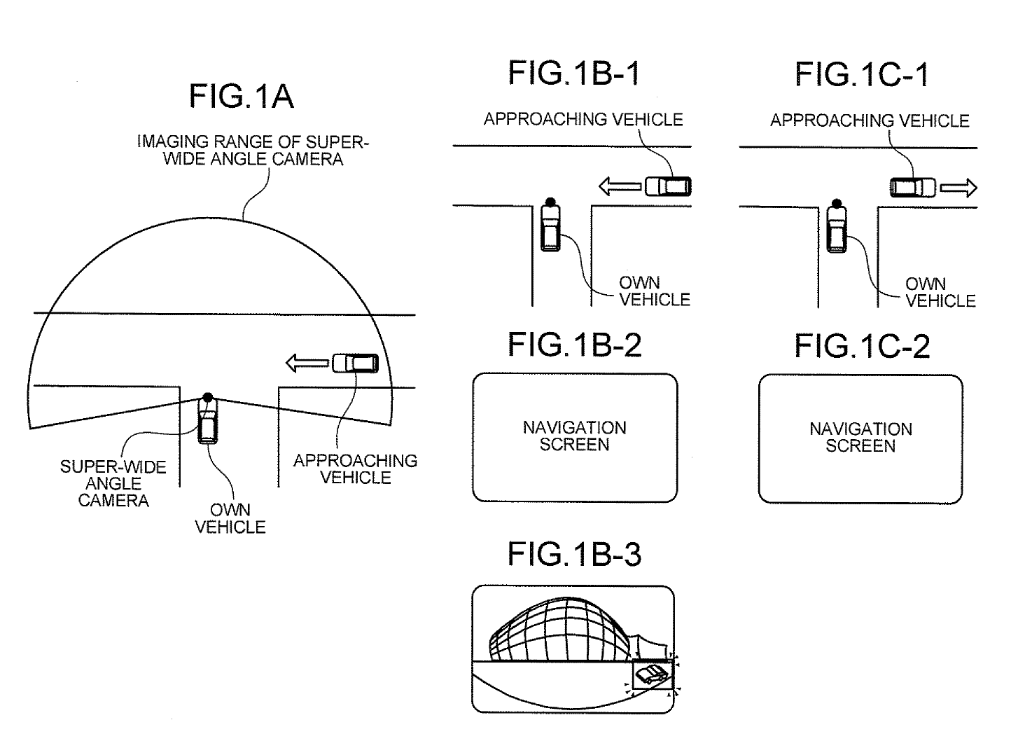

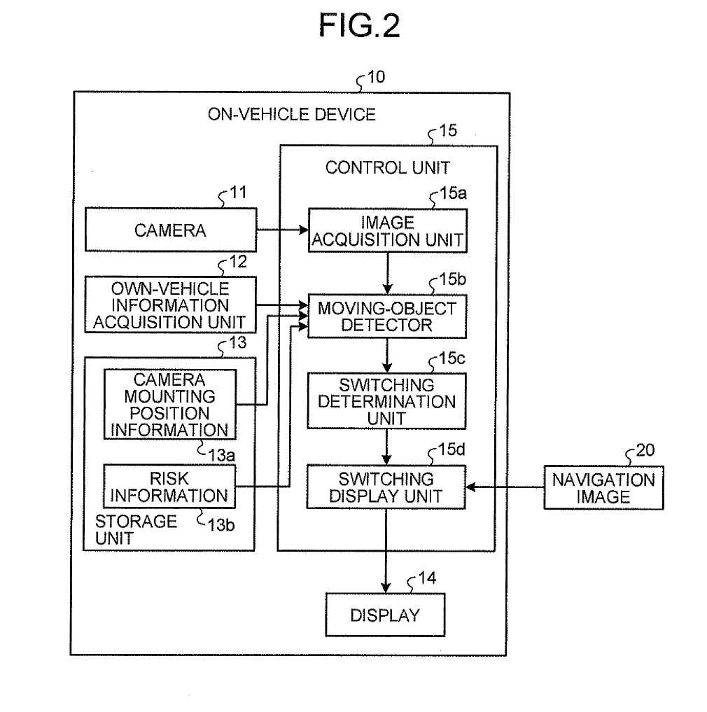

Preferred embodiments of the on-vehicle device and the recognition support system according to the present invention will be explained in detail below with reference to the accompanying drawings. In the following, an overview of the on-vehicle device and the recognition support system according to the present invention will be explained with reference to FIGS. 1A to 1C-2, and then the embodiments of the on-vehicle device and the recognition support system according to the present invention will be explained with reference to FIG. 2 to FIG. 9.

First, the overview of the on-vehicle device and the recognition support system according to the present invention will be explained with reference to FIGS. 1A to 1C-2. FIGS. 1A, 1B-1 to 1B-3, 1C-1, and 1C-2 are diagrams illustrating the overview of the on-vehicle device and the recognition support system according to the present invention.

As shown in FIGS. 1A, 1B-1 to 1B-3, 1C-1, and 1C-2, the on-vehicle device and the recognition support system according to the present invention detect a moving object based on an image imaged by a camera mounted on an own vehicle, and determine whether there is a risk that the detected moving object collides with the own vehicle.

Then, only when the determined risk of collision satisfies predetermined conditions, the on-vehicle device and the recognition support system according to the present invention switch from a screen displayed on a display provided in the own vehicle or from a navigation screen to a camera image, and display the camera image thereon.

More specifically, the on-vehicle device and the recognition support system according to the present invention are mainly characterized in that only when the risk of collision is high, switching to the camera image is performed, which makes it possible to reduce a switching frequency and perform recognition support for the driver while causing the driver to maintain a sense of caution against a dangerous object.

The characteristic points will be specifically explained below. As shown in FIG. 1A, the on-vehicle device according to the present invention is connected to a super-wide angle camera mounted on the front of the own vehicle. An imaging range of the super-wide angle camera is an area indicated as a circular arc in this figure, which is a wide field of view including the sides ahead of the vehicle being blind corners for the driver.

For example, as shown in FIG. 1A, when the own vehicle is about to enter an intersection, the super-wide angle camera can capture an image of an approaching vehicle running toward the own vehicle side from the road on the right side of the intersection.

Here, as shown in FIG. 1B-1, the own vehicle is entering the intersection, and an approaching vehicle is running toward the own vehicle side from the road on the right side of the intersection. The super-wide angle camera mounted on the own vehicle images an image on the right side ahead of the vehicle including the approaching vehicle.

Then, the on-vehicle device according to the present invention detects whether there is a moving object based on the image imaged by the super-wide angle camera (hereinafter described as “camera image”). The on-vehicle device according to the present invention also acquires own vehicle information including a running speed, a running direction, and a running position of the own vehicle based on information of various sensors, and acquires peripheral information based on information received from various radars mounted on the own vehicle. Here, the peripheral information includes a distance between the own vehicle and the moving object, and a moving direction of the moving object with respect to the own vehicle and a moving speed thereof.

The on-vehicle device according to the present invention determines whether the moving object is approaching the own vehicle based on the own vehicle information and the peripheral information.

Subsequently, the on-vehicle device according to the present invention, when it is determined that the moving object is approaching the own vehicle, predicts how much time is left before the own vehicle and the moving object collide with each other based on the distance between the own vehicle and the moving object and the running speed or the like, and calculates the time as a collision prediction time.

Thereafter, the on-vehicle device according to the present invention, when the calculated collision prediction time is a predetermined threshold value or less, determines that the risk of collision between the own vehicle and the moving object approaching the own vehicle is very high.

Therefore, the on-vehicle device according to the present invention switches from the screen already displayed on the display unit such as a display provided in the on-vehicle device, herein, from the navigation screen (see FIG. 1B-2) to a camera image (see FIG. 1B-3), and displays the camera image thereon.

Furthermore, as shown in FIG. 1B-3, the on-vehicle device according to the present invention highlights the moving object having the high risk of collision in such a manner that a frame is caused to blink or a color of the moving object is changed.

On the other hand, in FIG. 1C-1, the own vehicle is entering the intersection and another vehicle is running in a direction away from the own vehicle along the road on the right side of the intersection. In this case, the on-vehicle device according to the present invention determines that the other vehicle is not an approaching vehicle, so that the switching to the camera image is not performed and the display of the navigation screen is kept as it is (see FIG. 1C-2).

Thus, the on-vehicle device and the recognition support system according to the present invention detect the moving object based on the image imaged by the camera mounted on the own vehicle, and calculate, if the detected moving object is approaching the own vehicle, a collision prediction time indicating how much time is left before the own vehicle and the moving object collide with each other.

Then, when the calculated collision prediction time is the predetermined threshold value or less, the on-vehicle device and the recognition support system according to the present invention switch from a screen already displayed on the display unit to a camera image, and display the camera image thereon.

Therefore, according to the on-vehicle device and the recognition support system of the present invention, it is possible to allow the driver to reliably recognize the presence of the moving object that is approaching the own vehicle from the blind corner for the driver while causing the driver to maintain a sense of caution against the dangerous object.

An example of the on-vehicle device and the recognition support system whose overview has been explained with reference to FIGS. 1A to 1C-2 will be explained in detail below. First, a configuration of an on-vehicle device 10 according to the present embodiment will be explained below with reference to FIG. 2.

FIG. 2 is a block diagram of the configuration of the on-vehicle device 10 according to the present embodiment. FIG. 2 selectively shows only constituent elements required to explain the characteristic points of the on-vehicle device 10.

As shown in FIG. 2, the on-vehicle device 10 includes a camera 11, an own-vehicle information acquisition unit 12, a storage unit 13, a display 14, and a control unit 15. The storage unit 13 stores therein a camera mounting position information 13a and risk information 13b. Furthermore, the control unit 15 includes an image acquisition unit 15a, a moving-object detector 15b, a switching determination unit 15c, and a switching display unit 15d.

The camera 11 can image a peripheral image around the own vehicle. For example, the super-wide angle camera can capture an image in a wide field of view (here, 190 degrees) through a special-purpose lens with short focal length or the like. The camera 11 is mounted on the front of the own vehicle, and captures frontward, leftward, and rightward images of the vehicle. The present embodiment explains the case where the camera 11 is mounted on the front of the vehicle, however, the camera 11 may be mounted on the rear side, the left side, or the right side of the vehicle.

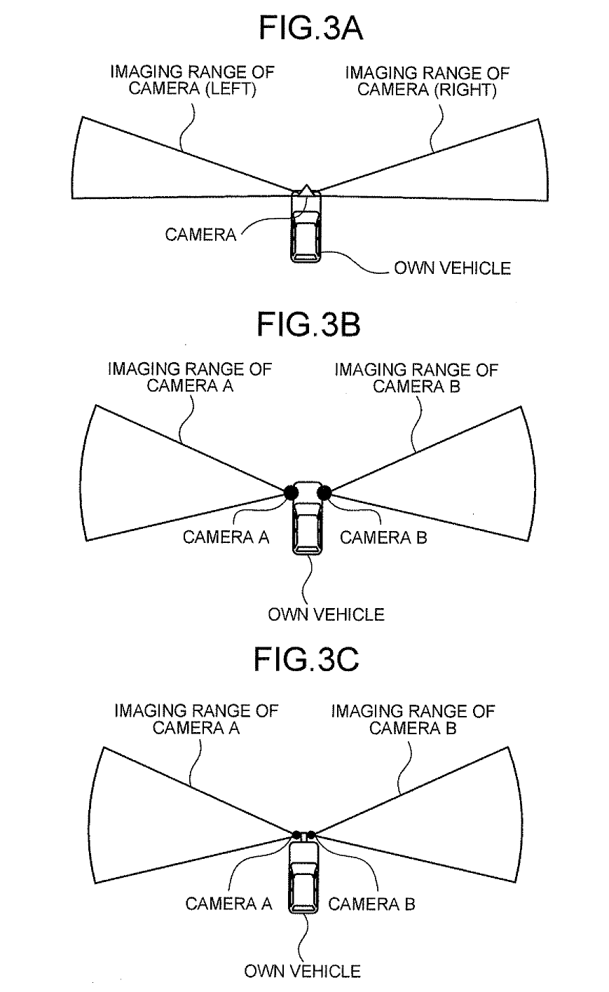

Here, a mounting pattern of the camera 11 will be explained below with reference to FIGS. 3A to 3C. FIGS. 3A to 3C are diagrams illustrating examples of the mounting pattern of the camera 11. As shown in FIG. 3A, by mounting a camera with a prism on the front of the own vehicle, images in two directions (an imaging range (right) of the camera and an imaging range (left) thereof) can be simultaneously imaged by a single unit of camera.

As shown in FIG. 3B, an imaging range in a case where a camera A is mounted on the left side in the front of the own vehicle and a camera B is mounted on the right side in the front thereof becomes two ranges indicated by circular arcs in FIG. 3B. Furthermore, as shown in FIG. 3C, a camera mounting unit is provided in the front of the own vehicle, and an imaging range in a case where two cameras are mounted on the right and left sides of the camera mounting unit becomes also two ranges indicated by circular arcs in FIG. 3C. In both cases, ranges that become blind corners for the driver can be imaged.

Referring back to the explanation of FIG. 2, the explanation of the on-vehicle device 10 will be continued. The own-vehicle information acquisition unit 12 is a device configured with various sensors, for example, a gyro sensor, a rudder angle sensor, a GPS (Global Positioning System) receiver, or a speed sensor, that detect physical quantities such as a position and a movement of the own vehicle.

The own-vehicle information acquisition unit 12 acquires own-vehicle information including a running speed, a running direction, and a running position of the own vehicle. More specifically, the own-vehicle information acquisition unit 12 acquires angle information detected by the gyro sensor, and acquires the running direction of the own vehicle based on to which direction a steering wheel of the own vehicle is directed detected by the rudder angle sensor. In addition, the own-vehicle information acquisition unit 12 acquires the running position of the own vehicle through information received from the GPS receiver, and acquires the running speed of the own vehicle through information from the speed sensor. The own-vehicle information acquisition unit 12 also performs the process of transferring the acquired own-vehicle information to the moving-object detector 15b.

The storage unit 13 is configured with storage devices such as a nonvolatile memory and a hard disk drive. The storage unit 13 stores therein a mounting position of the camera 11 (see FIGS. 3A to 3C) as the camera mounting position information 13a, and also stores therein the risk information 13b. It should be noted that details of the risk information 13b will be explained later.

The display 14 is a display device that displays an image imaged by the camera 11 and displays an image received from any device other than the on-vehicle device 10. Here, the display 14 receives a navigation image 20 indicating a road map and a route to a destination from a car navigation device and displays the received image. However, the display 14 may receive an image from a DVD (Digital Versatile Disk) player or the like and display the received image. Although the car navigation device and the DVD player are provided separately from the on-vehicle device 10, they may be integrated into the on-vehicle device 10.

The control unit 15 controls the entire on-vehicle device 10. The image acquisition unit 15a is a processor that performs a process of acquiring an image imaged by the camera 11 (hereinafter described as “camera image”). The image acquisition unit 15a also performs a process of transferring the acquired camera image to the moving-object detector 15b.

The moving-object detector 15b is a processor that detects a moving object approaching the own vehicle by calculating optical flows based on the camera image and that sets the degree of risk based on the risk information 13b.

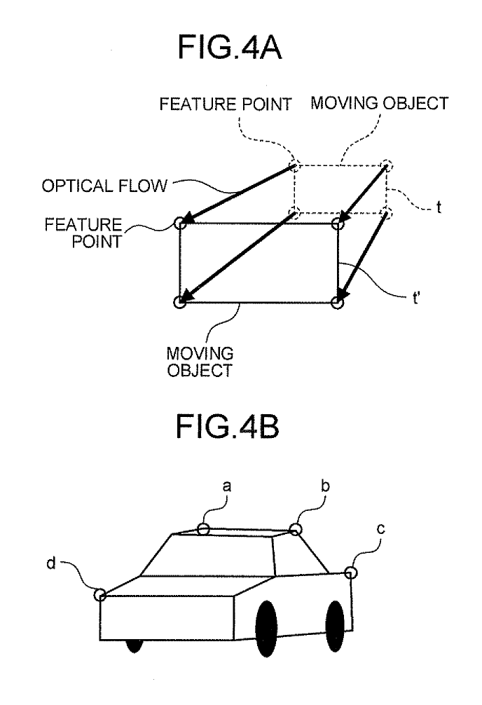

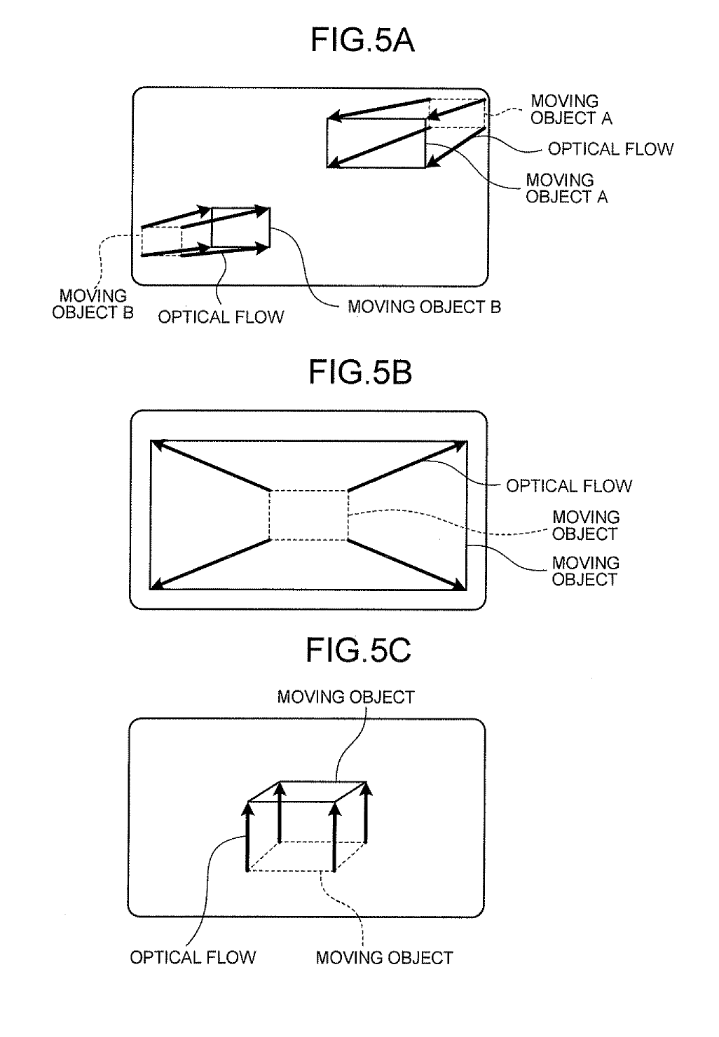

Here, the specific moving-object detection process executed by the moving-object detector 15b and the risk information 13b will be explained with reference to FIG. 4A to FIG. 5C. FIGS. 4A and 4B are diagrams for explaining the moving-object detection process. FIG. 4A is a diagram for explaining the optical flows, and FIG. 4B represents one example of representative points. The optical flow mentioned here is a movement of an object in temporally continuous images indicated by a vector.

FIG. 4A represents temporally continuous two images in a superimposed manner. An image at time t is indicated by dashed lines, and an image at time t′ is indicated by solid lines. The time t is set as a time previous to the time t′.

First, the moving-object detector 15b detects feature points from the image at the time t. Here, four points indicated by dashed line circles are detected as the feature points. Subsequently, the moving-object detector 15b detects feature points from the image at the time t′. Here, four points indicated by solid line circles are detected as the feature points. Then, the moving-object detector 15b detects vectors from the feature points at the time t to the feature points at the time t′ as optical flows respectively.

In order to specify directions of the optical flows relative to the own vehicle based on the mounting position of the camera 11, the moving-object detector 15b acquires the camera mounting position information 13a to specify the directions of the optical flows with respect to the own vehicle. By subtracting the movement of the own vehicle from the generated optical flows, the moving-object detector 15b can detect the movement vector of the object (hereinafter simply described as “movement vector”). The moving-object detector 15b may detect the moving object by correcting the camera image, the movement vector, or the like using the mounting pattern of the camera 11 explained with reference to FIGS. 3A to 3C, however, this point will be explained later with reference to FIGS. 5A to 5C.

The moving-object detector 15b then detects whether there is a moving object approaching the own vehicle based on the detected movement vector. If the length of the movement vector is longer than 0, then the moving-object detector 15b recognizes the object as being moving and thus determines the object as a moving object.

The moving object is detected based on the length of the movement vector as 0, however, the moving object may be detected using a predetermined threshold value as reference. Furthermore, there is no need to use all the detected feature points for a predetermined object. As shown in FIG. 4B, when point a, point b, point c, and point d are detected as feature points, then, for example, the point c and the point d may be extracted as representative points for detecting the moving object. Thus, the moving-object detector 15b detects the moving object.

The moving-object detector 15b detects the moving object by calculating the optical flows, however, may detect the moving object using a pattern matching method or a clustering method.

Subsequently, the risk information 13b used when the moving-object detector 15b executes the risk setting process will be explained below with reference to FIGS. 5A to 5C. FIGS. 5A to 5C are diagrams for explaining the risk information 13b. The risk information 13b is information related to the degree of risk preset in association with a situation including the directions of the optical flows, the mounting position of the camera 11, and the own-vehicle information. More specifically, the on-vehicle device and the recognition support system according to the present invention set the risk information 13b in the following manner.

Each of FIGS. 5A, 5B, and 5C represents temporally continuous two images, of camera images imaged by the camera 11, in a superimposed manner. An image at a predetermined time is indicated by a dashed line and an image after the predetermined time is indicated by a solid line.

First, a case where the mounting position of the camera 11 is on the front side will be explained. In FIG. 5A, the optical flows of a moving object A and a moving object B are directed toward the center of the screen. In this case, the moving object A is approaching the own vehicle from the right side thereof and the moving object B is approaching the own vehicle from the left side thereof. Therefore, because the moving objects are approaching the own vehicle from its right side and left side which are blind corners for the driver, this situation is set as a “high degree of risk”.

Subsequently, optical flows in directions different from these in FIG. 5A will be explained below. In FIG. 5B, the optical flows of a moving object are directed outward in the screen. In this case, the moving object is approaching from the front side, and because the driver can visually recognize the moving object, this situation is set as a “low degree of risk”.

In FIG. 5C, optical flows of a moving object are directed upward. In this case, the moving object is running ahead of the own vehicle, and because the size of the moving object is not changed, it is determined that the moving object is not an approaching vehicle, and thus, this situation is set as a “low degree of risk”.

Subsequently, a case where the mounting position of the camera 11 is not on the front side will be explained below. For example, if the image of FIG. 5A is imaged by the camera 11 mounted on the left side, the moving object A is approaching from the front side of the own vehicle, while the moving object B is approaching from the rear side of the own vehicle. However, because the driver can visually recognize these moving objects, this situation is set as a “low degree of risk”.

If the image of FIG. 5B is imaged by the camera 11 mounted on the rear side and the running speed of the own vehicle is very high, then it is assumed that it is driving along an expressway, and it is therefore determined that a moving object approaching from the rear side is very dangerous, and this situation is set as a “high degree of risk”.

Meanwhile, if the image of FIG. 5C is imaged by the camera 11 mounted on the left side and the running speed of the own vehicle is very high, then it is assumed that the detected moving object is a vehicle that is about to merge onto the expressway from an entrance of the expressway which is located at altitude lower than the own vehicle, and this situation is set as a “high degree of risk”.

In this manner, the risk information 13b includes degrees of risks which are preset in association with the situations. The risk information 13b is not limited thereto, and thus the degrees of risks are set in association with various situations. In addition, the explanation is made so that each situation is set as a high degree of risk or a low degree of risk, however, the degrees of risks may be subdivided and set according to each degree of risk.

The moving-object detector 15b acquires the degree of risk in association with the situation stored in the risk information 13b based on the directions of the optical flows of the detected moving object, the mounting position of the camera 11, and the own-vehicle information, and sets the acquired degree of risk as a degree of risk of the moving object.

In this manner, the moving-object detector 15b detects the moving object approaching the own vehicle based on the optical flows, and sets the degree of risk with respect to the detected moving object based on the risk information 13b.

Referring back to the explanation of FIG. 2, the explanation of the on-vehicle device 10 is continued. The switching determination unit 15c is a processor that performs, when the moving object approaching the own vehicle is detected by the moving-object detector 15b, the process of determining whether switching from the navigation image 20 to the camera image is performed. Here, the switching determination unit 15c may determine whether the switching to the camera image is performed in consideration of the degree of risk of the moving object set by the moving-object detector 15b.

The switching display unit 15d is a processor that performs the process of switching to the camera image acquired by the image acquisition unit 15a and displaying the camera image on the display 14 when it is determined by the switching determination unit 15c that the switching is performed from the navigation image 20 to the camera image.

Meanwhile, when it is determined by the switching determination unit 15c that the switching is not performed from the navigation image 20 to the camera image, the switching display unit 15d continuously acquires the navigation image 20 and displays it on the display 14.

The switching display unit 15d may highlight the moving object to be displayed on the display 14. For example, the switching display unit 15d may superimpose the moving object on the camera image and display the speed of the moving object and the distance between the moving object and the own vehicle.

The switching display unit 15d may also highlight the moving object according to the degree of risk of the moving object set by the moving-object detector 15b, to be displayed on the display 14. For example, the switching display unit 15d may display an enclosing frame around the moving object with a high degree of risk, may blink the enclosing frame or the entire image, or may change the color for display. Furthermore, the switching display unit 15d may emit alarm sound and vibrate a seat belt based on the degree of risk to inform the driver of the risk.

The switching display unit 15d also performs processes for switching to a camera image, displaying the camera image on the display 14, and after a predetermined time passes, returning to the image previous to the switching (here, navigation image 20).

In the above, the display is returned to the navigation image 20 after the passage of the predetermined time. The present invention, however, is not limited thereto. For example, the switching display unit 15d may return the display to the navigation image 20 in response to detection that an accelerator of the own vehicle is in an on-state, or may continuously display the camera image during detection of a moving object approaching the own vehicle even if the acceleration becomes on.

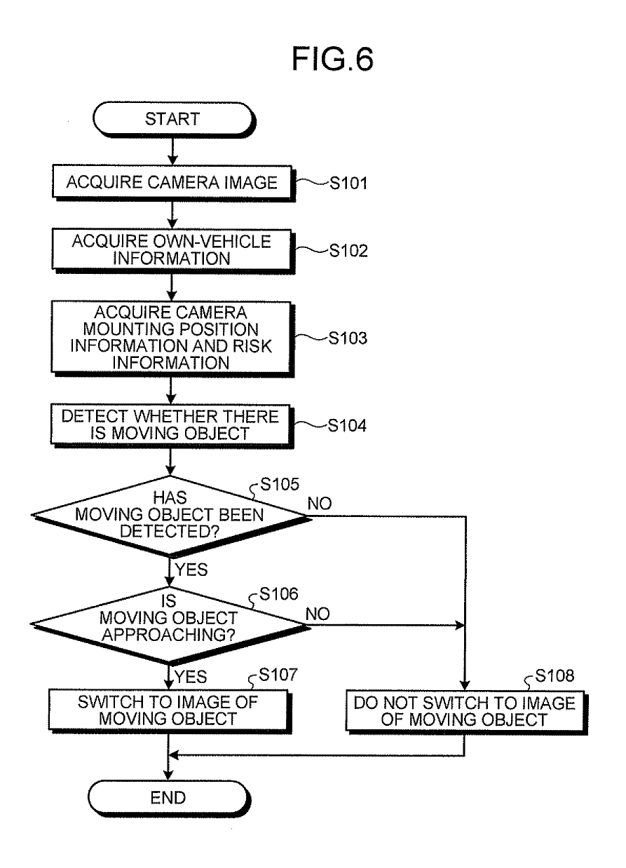

Next, the processes executed by the on-vehicle device 10 and the recognition support system according to the present embodiment will be explained below with reference to FIG. 6. FIG. 6 is a flowchart representing an overview of a procedure for a recognition support process executed by the on-vehicle device. The process executed by the on-vehicle device 10 at the time of detecting that the own vehicle enters the intersection will be explained below.

As shown in FIG. 6, the image acquisition unit 15a acquires an image imaged by the camera 11 (Step S101), and the moving-object detector 15b acquires the own-vehicle information acquired by the own-vehicle information acquisition unit 12 (Step S102).

Furthermore, the moving-object detector 15b acquires the camera mounting position information 13a and the risk information 13b stored in the storage unit 13 (Step S103). Then, the moving-object detector 15b detects whether there is a moving object based on the camera image acquired at Step S101, the own-vehicle information acquired at Step S102, and the camera mounting position information 13a and the risk information 13b acquired at Step S103 (Step S104).

The switching determination unit 15c determines whether the moving-object detector 15b has detected the moving object (Step S105), and determines, when the moving object has been detected (Yes at Step S105), whether the detected moving object is approaching the own vehicle (Step S106).

Then, when it is determined that the detected moving object is approaching the own vehicle (Yes at Step S106), then the switching display unit 15d switches to a camera image and displays the camera image on the display (Step S107), and ends the recognition support process executed by the on-vehicle device 10.

Meanwhile, when it is determined that the detected moving object is not approaching the own vehicle (No at Step S106), then the switching display unit 15d does not switch to the camera image, but displays the navigation image 20 as it is (Step S108), and ends the process.

Furthermore, when the moving object is not detected (No at Step S105), the switching display unit 15d does not also switch to the camera image and displays the navigation image 20 as it is (Step S108), and ends the process.

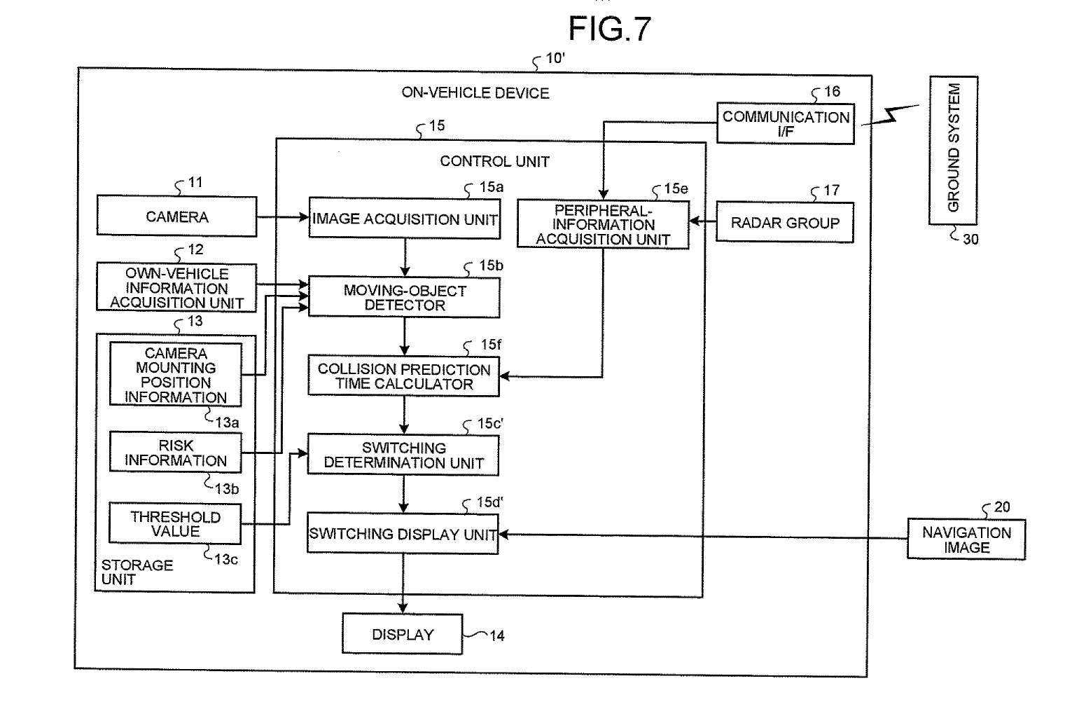

Incidentally, the present embodiment has explained the case where it is determined whether the display is to be switched to the camera image, based on the camera image, the own-vehicle information, and also based on the camera mounting position information 13a and the risk information 13b. However, the present invention is not limited thereto. Therefore, there will be explained below, with reference to FIG. 7 to FIG. 9, a modification of a case where any information for the periphery of the own vehicle other than the camera image is acquired and it is then determined whether the display is to be switched to the camera image.

First, a configuration of a recognition support system according to the modification will be explained below with reference to 7. FIG. 7 is a block diagram of a configuration of the recognition support system according to the modification. In FIG. 7, the same reference numerals are used for portions that have the same functions as these in FIG. 2 based on comparison therebetween, and only functions different from FIG. 2 will be explained below in order to explain its characteristic points.

As shown in FIG. 7, the recognition support system according to the modification includes an on-vehicle device 10′ and a ground system 30. The on-vehicle device 10′ has a function for acquiring any peripheral information around the own vehicle other than images captured by the camera 11, which is different from the on-vehicle device 10 in FIG. 2. More specifically, the on-vehicle device 10′ includes, in addition to the functions explained with reference to FIG. 2, a communication I/F (interface) 16, a radar group 17, a peripheral-information acquisition unit 15e, and a collision prediction time calculator 15f. The storage unit 13 stores therein threshold value 13c used for determination on switching.

The ground system 30 is a system that detects a vehicle running along a road by various sensors such as infrastructure sensors installed on the road, and manages information for road conditions such as congestion on the road and an accident. The ground system 30 also has a function for performing wireless communication with the on-vehicle device 10′ and transmitting the information for the road conditions to the on-vehicle device 10′.

The communication I/F 16 of the on-vehicle device 10′ is configured with communication devices for data transmission/reception through wireless communication with the ground system 30. For example, the on-vehicle device 10′ receives congestion situation of the road from the ground system 30 through the communication I/F 16.

The radar group 17 is a group of radar devices such as a millimeter-wave radar and a laser radar, that transmits an electromagnetic wave to an object and measures a reflective wave of the object to thereby acquire a distance to the object and a direction thereof. The radar group 17 acquires peripheral information around the own vehicle including a distance between the own vehicle and the moving object, an approaching direction of the moving object with respect to the own vehicle, and a moving speed of the moving object. The radar group 17 also performs a process of transferring the acquired peripheral information to the peripheral-information acquisition unit 15e. It should be noted that the radar group 17 may be configured with a single radar device.

The peripheral-information acquisition unit 15e is a processor that performs a process of acquiring the peripheral information around the own vehicle from the ground system 30 and the radar group 17. The peripheral-information acquisition unit 15e also performs a process of transferring the acquired peripheral information around the own vehicle to the collision prediction time calculator 15f.

The collision prediction time calculator 15f is a processor that performs processes of predicting how much time is left before the own vehicle and the moving object collide with each other based on the own-vehicle information received from the moving-object detector 15b and the peripheral information acquired by the peripheral-information acquisition unit 15e, and of calculating the time as a collision prediction time.

A switching determination unit 15c′ is a processor that performs a process of determining whether the display is to be switched from the navigation image 20 to the camera image by comparing the collision prediction time calculated by the collision prediction time calculator 15f with the threshold value 13c.

More specifically, the switching determination unit 15c′, when the collision prediction time is the threshold value 13c or less, recognizes that the risk of collision between the own vehicle and the moving object approaching the own vehicle is very high and determines that the display is switched to the camera image.

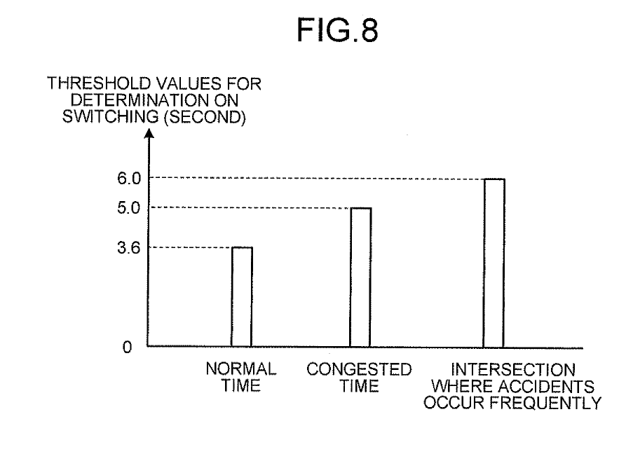

The threshold value 13c used for determination on switching may be varied by the switching determination unit 15c′ based on the peripheral information acquired by the peripheral-information acquisition unit 15e. Here, a method of varying the threshold value 13c executed by the switching determination unit 15c′ will be explained below with reference to FIG. 8.

FIG. 8 is a diagram for explaining one example of the method of varying the threshold value 13c. As shown in this figure, for example, the threshold value 13c of the collision prediction time used to determine whether the display is to be switched to the camera image is 3.6 seconds in normal time.

However, when the information indicating that the intersection where the own vehicle enters is congested is obtained through the peripheral information acquired by the peripheral-information acquisition unit 15e, the threshold value 13c for the determination on switching may be increased. For example, the switching determination unit 15c″ may vary the threshold value 13c from 3.6 seconds to 5.0 seconds and perform the determination on switching.

When the information indicating that the intersection where the own vehicle enters is an “intersection where accidents occur frequently” is obtained from the peripheral information acquired by the peripheral-information acquisition unit 15e, the threshold value 13c for determination on switching due to the variation may be prolonged from 3.6 seconds to 6.0 seconds. By varying the threshold value 13c depending on the situation in this manner, safety can be secured.

Referring back to the explanation of FIG. 7, the explanation of the on-vehicle device 10′ will be continued. A switching display unit 15d′ is a processor that performs a process of switching, when the switching determination unit 15c′ determines that the display is switched from the navigation image 20 to a camera image, to the camera image acquired by the image acquisition unit 15a and displaying the camera image on the display 14.

It should be noted that the switching display unit 15d′ may highlight the moving object according to the collision prediction time calculated by the collision prediction time calculator 15f to be displayed on the display 14. For example, the switching display unit 15d′ may display an enclosing frame around the moving object of which collision prediction time is very short, blink the enclosing frame or the entire image, or change the color for display.

Moreover, the switching display unit 15d′ may emit alarm sound or vibrate a seat belt according to the collision prediction time to inform the driver of the risk.

In this manner, in the present modification, determination accuracy is improved by determining whether switching to the camera image is performed according to the collision prediction time calculated based on the peripheral information acquired from the ground system 30 and the radar group 17 in addition to the determination on the switching executed in the embodiment. This allows the switching frequency of the image to be reduced and recognition support for the driver to be performed while causing the driver to maintain a sense of caution against a dangerous object.

FIG. 7 shows the case where the on-vehicle device 10′is provided with the radar group 17 and acquires the peripheral information from the ground system 30 through the communication I/F 16 of the on-vehicle device 10′. However, the radar group 17 may be omitted, and the peripheral information may be acquired only from the ground system 30. Alternatively, the ground system 30 may be omitted, and required peripheral information may be acquired by the radar group 17.

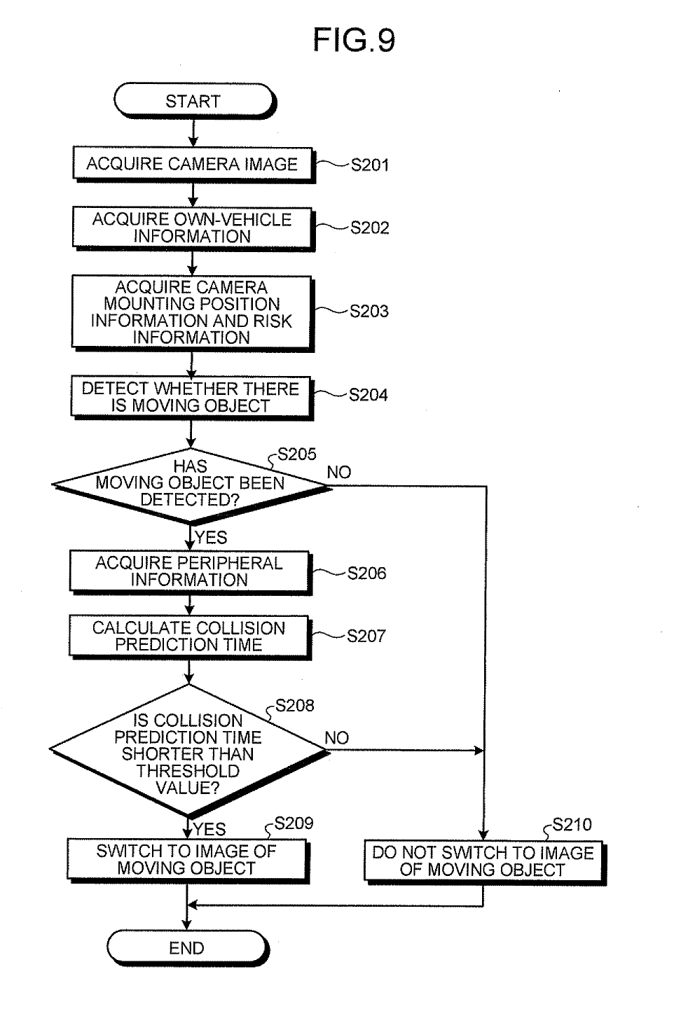

Next, processes executed by the on-vehicle device 10′ and the recognition support system according to the modification will be explained below with reference to FIG. 9. FIG. 9 is a flowchart representing the modification of a procedure for a recognition support process executed by the on-vehicle device. Because the processes at Step S201 to Step S205 shown in FIG. 9 are the same as these at Step S101 to Step S105 explained with reference to FIG. 6, explanation thereof is omitted.

At Step S206, the peripheral-information acquisition unit 15e, when the moving object is detected by the moving-object detector 15b (Yes at Step S205), acquires peripheral information (Step S206).

Then, the collision prediction time calculator 15f calculates a collision prediction time based on the own-vehicle information and the peripheral information (Step S207), and the switching determination unit 15c′ determines whether the collision prediction time is shorter than the threshold value 13c (Step S208).

Subsequently, the switching display unit 15d′, when the collision prediction time is shorter than the threshold value 13c (Yes at Step S208), switches from the navigation image 20 to a camera image (Step S209), and ends the recognition support process executed by the on-vehicle device 10′.

Meanwhile, the switching display unit 15d′, when it is determined that the collision prediction time exceeds the threshold value 13c (No at Step S208), does not switch to the camera image of the moving object but displays the navigation image 20 as it is (Step S210), and ends the process.

As explained above, in the on-vehicle device and the recognition support system according to the present embodiment and the present modification, the on-vehicle device is configured so that the camera acquires an image obtained by imaging a peripheral image around a vehicle, the moving-object detector detects whether there is a moving object approaching the vehicle as an own vehicle from the peripheral image based on own-vehicle information indicating running conditions of the own vehicle, the switching display unit switches between images in a plurality of systems input to the display unit, and when the moving object is detected by the moving-object detector, the switching determination unit instructs the switching display unit to switch to the peripheral image. Therefore, it is possible to allow the driver to reliably recognize the presence of a moving object approaching the own vehicle from a blind corner for the driver while causing the driver to maintain a sense of caution against a dangerous object.

In the embodiment and the modification, when it is determined that the risk is high, the display is performed by switching from the navigation image to the camera image of the moving object, however, the display may be preformed by superimposing the camera image within the navigation image.

Furthermore, the embodiment and the modification have explained the example of performing display by switching a display screen like the navigation image which is not the camera image to the camera image. However, when a power supply for the display is off, the power supply for the display may be turned on to display the camera image.

As explained above, the on-vehicle device and the recognition support system according to the present invention are useful to cause the driver to maintain the sense of caution against a dangerous object, and are particularly suitable for the case where it is desired to allow the driver to surely recognize the presence of a moving object approaching the own vehicle from a blind corner for the driver.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An on-vehicle device mounted on a vehicle, comprising:
an image acquisition unit that acquires an image obtained by imaging a peripheral image around the vehicle;
a moving-object detector that, when the vehicle approaches an intersection, detects whether there is a moving object approaching the vehicle as an own vehicle from a right or a left direction of the intersection based on the peripheral image;
a switching unit that switches between images in a plurality of systems input to a display unit; and
a switching instruction unit that instructs the switching unit to switch to the peripheral image when the moving object is detected by the moving-object detector.

2. The on-vehicle device according to claim 1, further comprising:
a peripheral-information acquisition unit that acquires peripheral information including a moving direction and a moving speed of the moving object detected by the moving-object detector; and
a collision prediction time calculator that calculates a collision prediction time indicating how much time is left before the moving object and the own vehicle collide with each other based on the peripheral information acquired by the peripheral-information acquisition unit and own-vehicle information indicating running conditions of the own vehicle, wherein
the switching instruction unit, when the collision prediction time calculated by the collision prediction time calculator is a predetermined threshold value or less, instructs the switching unit to switch to the peripheral image.

3. The on-vehicle device according to claim 1, wherein the moving-object detector, when the vehicle approaches an intersection, detects whether there is a moving object approaching the own vehicle from the peripheral image.

4. The on-vehicle device according to claim 2, wherein
the peripheral information further includes attention-attracting information in association with map information, and
the switching instruction unit changes the predetermined threshold value based on the attention-attracting information.

5. The on-vehicle device according to claim 3, wherein
the peripheral information further includes attention-attracting information in association with map information, and
the switching instruction unit changes the predetermined threshold value based on the attention-attracting information.

6. The on-vehicle device according to claim 1, wherein the peripheral-information acquisition unit acquires information, as the peripheral information, received from a ground server device that performs wireless communication with the on-vehicle device.

7. A recognition support system comprising:
an on-vehicle device mounted on a vehicle; and
a ground server device that performs wireless communication with the on-vehicle device, wherein
the ground server device includes
a transmission unit that transmits peripheral information around the vehicle to the vehicle, and
the on-vehicle device includes
a reception unit that receives the peripheral information from the ground server device,
an image acquisition unit that acquires an image obtained by imaging a peripheral image around the vehicle,
a moving-object detector that detects whether there is a moving object approaching the vehicle as an own vehicle from the peripheral image based on the peripheral information received by the reception unit and own-vehicle information indicating running conditions of the own vehicle,
a switching unit that switches between images in a plurality of systems input to a display unit, and
a switching instruction unit that instructs the switching unit to switch to the peripheral image when the moving object is detected by the moving-object detector.
